(19) United States
(12) Patent Application Publication
(10) Pub. No.: US 2003/0004247 A1
(43) Pub. Date: Jan. 2, 2003

(54) Fire resistant materials and methods for production

(76) Inventors: Pascal Destandau, San Francisco, CA (US); William O'Keeffe, San Francisco, CA (US)

Correspondence Address: Sheldon R. Meyer, FLIESLER DUBB MEYER & LOVEJOY LLP, Fourth Floor, Four Embarcadero Center, San Francisco, CA, 94111-4156, US

(21) Appl. No.: 10/096,401

(22) Filed: Mar. 12, 2002

Related U.S. Application Data
(60) Provisional application No. 60/289,050, filed on May 4, 2001.

(51) Int. Cl. C08L 1/00; B32B 17/06; C08K 3/10

(52) U.S. Cl. 524/437; 523/179; 524/121; 428/426

(57) ABSTRACT

Fire resistant gels are provided that comprise a polymer material and a fire-retardant chemical. Fire-resistant transparent materials are provided that comprise plates of transparent material that are arranged parallel to each other but having a space therebetween. The plates can be spaced apart using spacers and the space can be filled with a fire-retardant gel comprising a polymer material and a fire-retardant chemical. For certain uses, fire-resistant gels can be applied to the surface of a structure subject to fire damage or can be provided in the interior of a wall, door or other structure. The gel is permitted to polymerize, thereby forming the completed fire-resistant coating or construction material. The fire-resistant material so produced can be used for construction purposes where vision, radiant heat protection, safety and a fire rating is required and where large surface area and thin dimensions are desirable. Fire-resistant gels of this invention can also be used in the shipping, motor vehicle, and aerospace industries.

### RELATED APPLICATION

This application claims priorityto U.S. Provisional Patent Application Serial No. 60/289,050, filed May 4, 2001, herein incorporated filly be reference.

### BACKGROUND

1. Field of the Invention

This invention relates to fire-resistant gels, glass and methods for their production. In particular, this invention relates to fire-resistant gels comprising a polymer and a fire-retardant chemical. More particularly, this invention relates to manufacture and use of fire-resistant materials used in construction industries. Even more particularly, this invention relates to transparent materials having a layer of fire-retardant gel between pieces of glass. Description of Related Art

Fire-resistant windows and other construction materials are desirable to protect persons and property from fire damage. In particular, fire resistant windows can protect persons and structures while allowing vision through the window. It can be important for fire-resistant windows to be highly transparent to visible light, yet not be destroyed or broken by a temperature gradient from inside the heated environment to the outside.

Certain prior art fire-resistant materials consist of two parallel panes of glass, separated by a space filled with an insulating material. U.S. Pat. No. 3,940,549 discloses insulating materials that consisting of a methylmethacrylate monomer, hydroxyalkylacrylate or diacetone acrylamide monomer, a chlorinated hydrocarbon, an antimony compound, a zinc compound and a catalyst-promoter system.

U.S. Pat. No. 4,071,649 discloses afire screening glazing panel having a plastic membrane and hydrated salts of aluminum, lead, tin, borates or phosphates.

U.S. Pat. No. 4,264,681 discloses a polymerized organic gel comprising 65-95% material having a high vaporization property and an adherence compound consisting of a silane.

U.S. Pat. No. 4,451,312 discloses a method for producing fire-resistant glass in which air is substantially removed from the materials filling a space between plates of glass.

U.S. Pat. No. 4,830,913 discloses afire-resistant glass consisting of two plates of glass separated by a metal frame, defining a space filled with a hydrogel comprising from about 70 to 90% water, 10 to 30% of a water soluble salt and an anticorrosive agent. The hydrogel is made from water-soluble monomers of an acrylic acid that is polymerized by addition of as catalytic component, such as a peroxide, and an accelerator, such as diethylaminopropionitrile or triethanolamine in glycol. A cross-linking agent such as N,N′-methylenebisacrylamide may also be used.

U.S. Pat. No. 5,124,208 discloses a laminated structure having 5 to 30% acrylamide in an aqueous solution of an alkanoic acid salt and a cross-linking agent such as N,N′-methylene bisacrylamide. A polymerization catalyst such as ammonium persulfate may then be added to increase the speed of polymerization.

U.S. Pat. No. 5,223,313 discloses a fire-resistant glass composed of two plates of glass defining a space having a hydrogel made from 2-hydroxy-3-methacyloxypropyl-trimethylammonium-chloride. A cross-linking agent, N-N′-methylenebisacrylamide can be used to increase the speed of polymerization.

U.S. Pat. No. 5,653,839 discloses a fire-resistant glass having a gel filled with an aqueous medium having a methacrylamide polymer, a metal oxide, and an anti-freezing agent.

However, the prior art does not disclose any fire-resistant polymer material or transparent material in an insulating unit with desirably high resistance to thermal degradation that can be made sufficiently thin and still meet fire-safety requirements.

### SUMMARY OF THE INVENTION

Thus, one object of this invention is the production of fire-resistant protective gels.

Another object is the production of fire-resistant construction materials having improved fire-resistive protection.

Another object of this invention is the production of fire-resistant transparent materials that are sufficiently thin and made in larger sizes than conventional fire-resistant transparent materials.

These and other objects are addressed by the manufacture of fire-resistant polymer materials comprising a polymer and one or more added fire-retardant chemicals. In aspects of this invention a plurality of fire-retardant chemicals maybe added to the gel to improve fire resistance. Further improvements in fire resistance can be achieved by cross-lining fire retardant chemicals with the polymer. We have unexpectedly found that certain fire-retardant chemicals can cross-link with the polymer material, can increase the stability of the polymer material, and/or can increase the retention of the fire-retardant chemical within the polymer, and thereby can improve the fire-resistance of the polymerized material.

Other embodiments of this invention provide fire-resistant polymers having low amounts of un-polymerized monomers, thereby providing increased mechanical strength of the polymer material. In such polymers, fire-retardant chemical can be strongly associated with the matrix of the polymer, thereby decreasing the loss ofany fire-retardant chemical from the polymer. By decreasing the loss of fire-retardant chemicals from the polymer, the fire-resistance of the polymer material can be improved.

Fire-resistant polymer materials can be used in a variety of different applications in the construction industry. In certain embodiments, fire-resistant transparent materials comprise one or more plates of transparent material having a fire-resistant polymer material on a surface or a portion of a surface. In other embodiments, a plurality (two or more) plates of transparent material can be separated by one or more gel-compatible spacers defining one or more gel spaces, and having a gel within at least one portion of at least one gel space, comprising a polymer material and a fire-retardant chemical. Fire-resistant materials can be placed inside doors or walls to provide fire protection. In other embodiments, fire-resistant materials can be coated onto surfaces of an object, such as a structure, to be exposed to fire, and thereby can protect that object from destruction. Additionally, fire-resistant gels can be incorporated into fabrics or felts for use in clothing or other flexible materials. In yet other embodiments, fire-resistant gels can be used in the maritime industries to protect ship hulls from fire. In certain of these embodiments, fire-retardant gel can be provided between hulls of double-hulled vessels. In other embodiments, a radiation shielding material, by way of example, lead metal, can be used to provide transparent, fire-resistant, radiation shields for use in the nuclear power industry.

Certain fire-retardant polymer materials can, when heated, produce a char having a dark surface on the side of the gel facing the source of heat (the inside surface of the gel) and a light surface on the outside surface of the gel facing the exterior of the heated space. When a fire-retardant chemical is polymerized along with the polymer matrix, the char can remain attached to the surface of the polymer on the side exposed to heat. The presence of such an attached char improves the fire-resistance properties of the polymer. In contrast, for materials in which the fire-retardant chemical is not polymerized with the matrix, the ashes tend to fall off, thereby exposing other portions of the polymer, thereby decreasing the fire-resistance of the polymer. Moreover, polymers of this invention can be intumescent, that is, when heated, bubbles can form, thereby increasing the thickness of the polymer, thereby increasing fire-resistance. Transparent fire-resistant materials of this invention can exhibit better fire-resistance than prior art materials, and therefore can be made thinner, with larger surface areas and therefore can have more desirable optical properties than prior art materials.

In certain embodiments, the transparent materials comprise glass, plastic or any other transparent material known in the glazing arts. The transparent material also can include annealed or laminated materials.

In certain other embodiments, methods for manufacturing fire-resistant transparent materials are provided.

### BRIEF DESCRIPTION OF THE FIGURES

This invention is described with respect to specific embodiments thereof. Other features of this invention are described in the Figures, in which:

FIGS. 1A and 1B depict a drawing of an embodiment of this invention comprising two plates of transparent material having a space between them filled with a fire-retardant gel of this invention.

FIG. 2 depicts a graph of heat of polymerization of fire-retardant acrylamide gels of this invention.

### DETAILED DESCRIPTION OF THE INVENTION

Fire-resistant polymers of this invention include materials that, above 10° C. and below 90° C., are transparent and substantially bubble-free. However, when heated, such as upon exposure to fire, certain fire-resistant polymers of this invention do not degrade rapidly, but rather, can form a char layer of charred polymer material, may expand (i.e., is “intumescent”), or both.

It can be highly desirable to provide a polymer material that both forms a char and is intumescent.

Fire-resistant transparent materials include embodiments in which a sheet or plate of transparent material has at least a portion of a surface having a fire-resistant material adhered thereto. In other embodiments, two or more sheets or plates of transparent material are arranged parallel to each other, forming a gap between them. Spacers can be used to hold the sheets or plates in proper alignment with each other. A fire-retardant chemical can be added to a polymer material, thereby forming a fire-retardant polymer gel, which can then be introduced into the space between the sheets. Once the polymer solidifies, the article can be prepared for particular applications.

In certain embodiments of this invention, the transparent sheet or plate materials can be any material known in the art to be transparent and to be compatible with the temperature of the environment and with the fire-retardant material between the plates of transparent material. For example, apiece of transparent plate material can be ⅛″, 3/16″, ¼″, ½″ or greater in thickness. However, for other applications, the transparent material can have any other desired dimension. In addition to tempered glass, laminated glass, plastics, fiberglass or any other transparent material known in the art may be used.

Pieces of transparent material can be separated by spacers composed of any gel- or polymer-compatible material. Examples of such gel-compatible material includes glass, ceramic, plastic, fiberglass and masonite. Other gel-compatible materials are known in the art, and all can be incorporated into the fire-resistant transparent materials of this invention.

I. Manufacture of Fire-Resistant Polymers

In general, polymers or gels suitable for use in this invention can include a polymer, a fire-retardant chemical an polymerization initiator, a polymerization accelerator, and/or a chelator. Generally, any polymer material that is compatible with the supporting material and can associate with the fire-retardant chemical can be used. Byway of example, a variety of silicas, acrylamides, plastics, aquagels and related materials are suitable. In certain examples, acrylamide polymers are desirable because they can be prepared easily from readily available materials.

Acrylamide (2-propeneamide; acrylic acid amide; C₃H₅NO) can be used to form polyacrylamide gels. Acrylamide can be used as a cross-linking agent for styrene based polyester resins, and can copolymerize with vinylidene chloride to form polyacrylates. Similarly, N-methylolacrylamide (C₄H₇NO₂), N-N-methylenebisacrylamide and similar materials can be used to make acrylamide polymers. Formaldehyde (CH₂O) and urea (CH₄N₂O) can be used to make so-called “urea” gels. Urea gels can also be made with melamine and acetaldehyde. Formaldehyde can also be used with melamine and/or phenols to make gels suitable foruse in aspects of this invention. Propylene oxide (C₃H₆O) can be used with polyethers, such as poly(ethylene propylene) glycol to make polyether polyol polymers.

Various epoxy resins, polyesters, polyurethanes and polyvinylbutyrates, poloxamers (synthetic block copolymers of ethylene oxide and propylene oxide), polyethylene glycol (polymers of ethylene oxide and water; PEG), polyethylene glycol monomethyl ether (formed from ethylene oxide and methanol) and polysorbates (formed from fatty acid esters of sorbitol copolymerized with ethylene oxide), and carbomers (polymers of acrylic acid cross-linked with allyl ethers) can be used as well.

In certain embodiments, silicates maybe advantageously used. Silicas comprises silicon dioxide (SiO₂) either in amorphous form or cross-linked to form crystalline structures. Silicates can be made from organic siloxanes or silanes. For example, tetraethylorthosilane (TEOS) is a molecule having the chemical formula: Si(O—C₂H₅)₄. When treated under acidic or alkaline conditions, the TEOS molecule can decompose into reactive intermediates including Si(O⁻)₂. This intermediate can react with others to form polymers of SiO₂. For such silicates, the type of precursor molecule is not crucial. Upon hydrolysis, TEOS produces ethyl alcohol. Chemically related alkylsilicates include tetramethylorthosilane (MEOS), and tetrapropylorthosilane (PEOS). It can be readily appreciated that other alkylsiloxanes can be precursors for silicates. It can be appreciated that numerous other types ofpolymers can be used to make fire-retardant gels of this invention.

Similarly, numerous fire-retardant chemicals can be used. Several classes of fire-retardants that are suitable include reactive organic phosphorous monomers, diols and polyols, oligomeric phosphate-phosphonates, tetrakis(hydroxymethyl)phosphonium salts, oligomeric vinylphosphonates, phosphites, and a variety of other phosphorous-containing polymers. Additionally, mesylated and tosylated celluloses may be used. Three general classes of fire retardants include antimony and other inorganic flame retardants, halogenated flame retardants, and phosphorous-containing flame retardants.

Thus, a variety of soluble retardants can be sued, and include salts containing bromine, chlorine, antimony, tin, molybdenum, phosphorous, aluminum and/or magnesium. Specifically, sodium antimonite, boric acid, sodium borate, stannous fluoride, stannous chloride, magnesium chloride, sodium chloride, ammonium phosphates, and melamine phosphates can be used.

Moreover, numerous reactive flame retardants maybe used. By “reactive” we mean that the fire-retardant chemical can for an interaction with the polymer material, the interaction characterized by increased affinity of the fire-retardant chemical with the polymer material. Increased affinity can be reflected in a tendency for the fire-retardant chemical to remain associated with the polymer. This interaction is in contrast with a simple mixture, in which the fire-retardant chemical and the polymer do not have any affinity for each other. The association of the fire-retardant chemical and the polymer can provide substantially increased fire resistance of the polymer. Examples of such interactions include the formation of covalent bonds, ionic bonds, Van Der Walls interactions and physical trapping of the chemical within the matrix of the polymer. However, any type of interaction that promotes the formation of a stable combination of fire-retardant chemical and the polymer matrix can provide improved fire-resistance. Reactive fire-retardant chemicals include, by way of example only, organophosphorous monomers, phosphorous-containing diols and polyols, phosphonomethylated ethers, amide-based systems with cyanamine, halogenated alkyl phosphates and phosphonates, and dialkyl phosphites and related materials.

The mechanism(s) of action of fire-resistant materials are not known with certainty. Without being limited to any particular theory or operability or mechanism of action, several mechanisms have been proposed. Halogenated flame retardants may function in a vapor phase either as a diluent or a heat sink or as a free-radical trap that stops or slows flame propagation. Phosphorous compound may function in a solid phase by forming a glaze or coating over substrates, there by preventing heat and/or oxidant from being maintained as required for sustained combustion. However, the scope of this invention is not intended to be limited to any particular theory for operability. The fire-resistant materials may work by one or more of the above mechanisms, or may operate by another, undefined mechanism.

Further descriptions of these fire-resistant materials are included in the Kirk Othmer Chemical Encyclopedia, volume 10. By way of example only, fire-retardant chemicals that can be used in conjunction with this invention include bromine and chlorine for a total of about 60%, organic halogen compounds, phosphorous containing polyol, boron-phosphate, modified organic halogens, di-linoleic acid/tri-linoleic acid/ethylene diamine copolymers, polyphosphate-nitrogen liquid, inorganic salts, acrylic polymer compounds, dibutyl butylphosphonate, antimony oxide, antimony peroxide, sodium borate, barium metaborate, alumina trihydrate, magnesium hydroxide, decabromodiphenyl oxides, vinyl bromide, dimethylphosphonate, and/or dibromoneopentyl glycol, Pyrovatex™ (dialkyl phosphorus carboxyl amide TMM; CIBA Specialty Chemicals), Pyrovatex CP New™ (dialkyl phosphorus carboxyl amide), Fyrol99™ (oligomeric 2-chloroethylphosphate; Akzo Nobel Chemicals, Inc.), Fyrol DMPP™ (dimethyl methylphosphonate; Akzo Nobel Chemicals, Inc.), Barfire PCR™ (Apollo Chemical Corporation), Barfire RE™ (“organic phosphate Y;” Apollo Chemical Corporation), Eaglechlor 10™ (“chlorinated parrafin W;” Eagle Systems Corporation), Eagleban F/RP-85NE (“Organic Phosphate X;” Eagle Systems Corporation) and Flamort X™ (“NT Aqua Fire Retardant;” Flamort Company Inc.); D “decabromodiphenyl oxide-polyacrylate.” Mineral hydrates, such as alumina tritrihydrate and magnesium sulfate heptahydrate maybe used in thermoset resins. These materials can be used singly or in combination without departing from the scope of this invention.

In fact, we have observed that flame retardants which belong to more than one class of flame retardant were more effective than those retardants belonging to only one class. By way of example only, panels prepared with magnesium chloride hexahydrate (MgCl₂)*6H₂O) performed better in burn tests than samples prepared with the same amount of sodium chloride (NaCl). We attribute the increased efficacy of the MgCl₂ solution to the fact that the material is both a metal halide (as is NaCl) and is a mineral hydrate, unlike NaCl, which is not hydrated.

In certain specific embodiments, the gel composition can comprise about 25% base monomer, which comprises about 44% distilled water, about 44% acrylamide, 0.13% methylene bisacrylamide, and about 12% formaldehyde. To the base monomer solution, about 12% magnesium chloride, about 51% distilled water, about 10% of a fire retardant, about 2% sodium persulfate and less than about 1% sodium tungstate can be used. In other embodiments, ammonium persulfate can be used. Other types of gels can be used satisfactorily if they are compatible with the fire-retardant chemical. Once formulated, gel is placed between the pieces of transparent material and the edges are sealed to form an intact piece of transparent, fire-resistant material.

It can be desirable to control the time needed for polymerization of the gels of this invention. Lag time is the time taken for a mixed solution of gel to polymerize. Lag time should be sufficiently long to permit the filling of spaces between panels before polymerization occurs. If the gel polymerizes too soon, then bubbles and other defects may appear in the gel, decreasing its performance and transparency. On the other hand, lag time should be sufficiently short to that once poured, the gel polymerizes completely within a desirably short time thereafter. Moreover, if the lag time is too long, the polymerization may not be complete, and free, unpolymerized monomers may remain in the gel. Unpolymerized monomers can decrease the efficiency of cross-linking the fire-retardant with the gel polymer, decreasing fire resistance of the finished product. Unpolymerized monomers can react later when the panel is exposed to heat and/or UV light. Those post polymerization reactions may cause cracks and bubbles within the finished panel.

To increase lag time, one can decrease the amount of catalyst in the gel mixture, increase the pH, provide some oxygen, and/or add sufficient sodium metabisulfite to scavenge only a portion of the oxygen in the gel. If too little catalyst is used however, polymerization may not be complete and unpolymerized monomers may contaminate the gel, degrading its fire-resistant properties.

II. Manufacture of Fire-Resistant Transparent Materials

To manufacture fire-retardant transparent materials of this invention, transparent plates are provided and aligned in approximately parallel fashion, with their facing surfaces separated by a gap to be filled with fire-retardant gel. The gel material is typically-manufactured using conventional methods. However, fire-retardant chemicals can be added to increase the ability of the gel and the transparent material to withstand elevated temperatures without incurring undesirable damage. In certain embodiments, the gel material can be manufactured using aqueous monomer solutions to which all components are added, then the mixture can be degassed before addition of polymerization initiators. Once polymerization initiators are added, the gel is pumped into the gap between the transparent plates and permitted to polymerize. After polymerization has taken place, the fire-resistant transparent material can be subsequently used to provide a transparent cover for a variety of different applications.

The fire-retardant material can either be made in a desired configuration or shape, such as circular, rectangular, triangular, or other desired shape. Alternatively, the fire-retardant material can be subsequently processed into desired shapes using methods known in the art. Once manufactured, the fire-retardant material can be inserted into, for example, a window, a door, or can be enclosed in a frame. In certain embodiments, a gel of this invention can be placed within walls, either in place of insulation, or in addition to insulation. For example, a wall made of two panels of wall-forming material, such as sheet rock, can be prepared with a gap between them, defining an interior space. Then, gel of this invention can be provided within the space to increase the fire-resistance of the wall. In certain of these embodiments, fire-resistant gel can be provided on one sheet of the wall-forming material, or alternatively, gel can be provided on both sheets of wall-forming material. In yet other embodiments, the entire space between wall-forming materials can be filled with fire-resistant gels of this invention. If desired, one can also provide thermal insulating material along with the gel.

III. Uses of Fire-Resistant Polymer Materials

Additionally, for certain uses, the fire-resistant gels of this invention can be applied to an exterior surface of an object, such as a structure. If such structures are near a fire, the fire-resistant gel can protect the structure from damage. The applications include those for schools, hospitals, factories, property lines and anyplace requiring a fire rating for safety of persons or property. The fire-resistant materials can be thinner, weigh less, have larger surface area, and can be more aesthetically pleasing than prior art fire-resistant transparent materials. The fire-resistant material can be used for any construction purpose where vision, radiant heat protection, safety and a fire rating is required. The materials of this invention therefore can have desirable performance characteristics in forms having larger surface areas (“lite sizes”) and smaller thicknesses than available in the prior art. Fire-resistant polymer materials can be applied in gel forms, foams and the like. It can be desirable to apply the mixture prior to polymerization, and to permit the material to polymerize before it is exposed to heat sufficient to cause damage to the structure.

In the nuclear power industry, it can be desirable to provide materials in nuclear reactor facilities that are both fire-resistant and radiation resistant. In certain embodiments, radiation shielding materials can be incorporated into the gels of this invention. Byway of example only, lead(Pb) particles or salts thereof can be added to the gel material in sizes from atomic size to microparticle dimensions of about 10-100 micrometers (μM). In certain of these embodiments used for windows, it can be desirable to use particles having sizes sufficiently small to maintain optical transparency of the gel. However, complete optical transparency is not necessary in all embodiments, and some embodiments can incorporate relatively larger amounts of radiation shield material and have somewhat reduced transparency, but without adversely affecting the desirable properties of the window. In other embodiments, in which optical transparency is not needed, the fire-resistant gels of this invention can be incorporated into containment vessels, concrete housing structures, bunkers, pipes, coolant systems, and other structures where fire-resistance and radiation shielding are desired.

Yet other embodiments of this invention include the manufacture of fire-resistant hulls for vessels, such as tanker ships that can carry flammable materials, such as gasoline, oil, kerosine, diesel fuel and the like. A coating of fire-resistant gel on the inside of a single hull can provide increased protection of the vessel's contents in situations in which fire on the exterior of the vessel is encountered. In other embodiments, double-hulled vessels can have fire-resistant gel placed in the space between the two hulls. In these embodiments, the gel can fill the space, thereby preventing flammable liquids or gasses from having access to the space between the hulls. Thus, the likelihood of fire between the vessel's hulls can be substantially decreased, thereby increasing the integrity of the hull, and thereby decreasing the likelihood of spills into the environment. Additionally, the fire-resistant properties of the gel can inhibit the spread of fire. In other embodiments, fire-resistant gels can be incorporated into other structures on vessels, including engine rooms, fuel lines and other structures that can be subjected to fire.

Similarly, land or airborne vehicles can incorporate fire-resistant gels of this invention. Such vehicles include cars, busses, trains, airplanes, rockets and the like. In these vehicles, the light weight of the fire-resistant gel can provide improved fire resistance without compromising the function of the vehicle.

In other applications, fire-resistant gels of this invention can be incorporated into fabrics, including both woven fabrics or felts. Incorporation of the gels of this invention into clothing can provide fire-resistant clothing for firefighters and other persons who maybe exposed to high temperatures. Gloves, socks, shoes, boots, gaiters, pants, shirts, vests, jackets, hats, masks, and may other types of clothing articles can be made fire-resistant by incorporation of the gels of this invention. In certain situations, in which it is necessary to provide a firefighter with breathing apparatus, the fire-resistant gels and materials of this invention can provide improved fire protection. Thus, hoses, cylinders, face masks, gauges, regulators, and the like can benefit from incorporation of fire-resistant materials of this invention.

In yet other embodiments, insulating materials can be incorporated into gels of this invention. Thus, gels comprising such fibers as Kevlar™, Nomex™, fiberglass, asbestos and other insulating materials can provide both fire resistance and resistance to undesired heating or cooling.

### EXAMPLES

In the examples below, specific materials and methods are described. However, the examples below are not intended to limit the scope of the invention. Rather, other possible materials and methods can be advantageously used to produce fire-resistant materials within the scope of this invention. Many other applications are possible, and all such uses are contemplated and are considered within the scope of this invention.

### Example 1

### Manufacture of a Monomer Solution

To manufacture a monomer solution of this invention, we prepared a solution consisting of44% distilled water, 44% acrylamide, 12% formaldehyde (37% solution) and 0.13% methylenebisacrylamide. To manufacture the monomer solution, we heated an aliquot of distilled water in a chemically inert vessel to a temperature of about 55° C. and added a sufficient amount of a 20% NaOH solution to raise the pH of the solution was between about 9.5 to about 10. We then slowly added 44% by weight of powdered acrylamide, with constant stirring, and maintained the temperature at about 38° C. or greater. The temperature then was allowed to increase to 55° C after which time we added 12% of a 37% solution of formaldehyde. We maintained the temperature of the solution at about 55° C. and stirred the solution for 2 hours, after which time, we transferred the monomer solution to a plastic drum. Alternatively, the following formula is suitable for manufacturing a monomer solution.

Distilled deionized water: 289 g; Flocryl 52 ST™ (which is a blend of N-methylolacrylamide and acrylamide): 58.238 g; NMA 2820 (a blend of acrylamide and N-methylolacrylamide) 9215 g; and formaldehyde (37%) 5877 g.

### Example 2

### Manufacture of a Polymerization Solution

We then used a sample of the above monomer solution to manufacture a polymerization solution for the gel of one embodiment of this invention. We prepared a solution containing 35% of the above monomer solution described in Example 1 containing 45% of a solution made of 50% water and 50% magnesium chloride and containing 20% of a clear 100% fire retardant material.

### Example 3

### Gel Processing I

The solution described above in Example 2 was then transferred to a stainless steel container. We then lowered a high-speed stirrer into the solution and stirred the solution for 3 minutes. We then reduced the temperature of the solution to 13° C. and added sufficient of the following materials to achieve the overall percentages indicated based on of the total monomer content in solution; triethanolamine to 0.45%, sodium persulfate 0.15% and sodium tungstate 0.03% and sufficient EDTA to chelate the copper which is added to Flocryl 52 ST™ to stabilize it and prevent polymerization and stirred for an additional 3 minutes. The mixture was then placed in a 250 liter container, the air was removed to decrease the formation of bubbles in the gel. The air had to be removed because the polymerization is a free radical step polymerization and oxygen is a free radical scavenger, which, if present, can decrease the efficiency of polymerization.

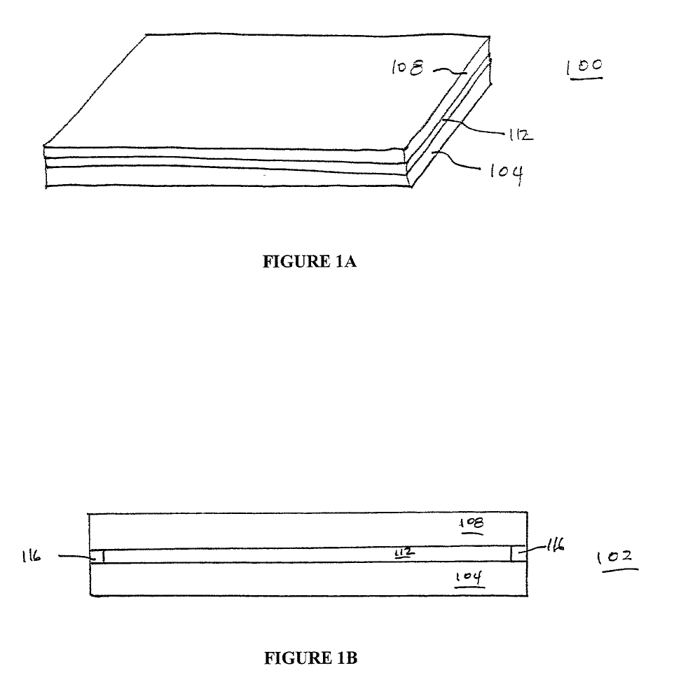

The fire-resistant material so produced are depicted in FIG. 1. FIG. 1A depicts a perspective view of one embodiment of this invention 100 having one plate of transparent material 104, a second plate of transparent material 108 defining a space therebetween. In the space, fire-resistant gel 112 is formed to complete the fire-resistant transparent material.

FIG. 1B depicts aside view of an alternative embodiment of this invention 102, similar to that shown in FIG. 1A but having a spacer to maintain the relative positions of the plates of transparent material. In this view, two plates of transparent material 104 and 108 are depicted, parallel to each other and defining a gel space therebetween. The space is maintained by spacers 116. The gel space is shown filled with fire-resistant gel 112.

Once the gel space is filled, valve 278 is closed and the gel 112 within the gel space is permitted to polymerize.

Once made, the fire-resistant material can be used to cover window openings, doors, walls, or inserted into frames for fireplaces, furnaces or other uses in which a temperature gradient is to be maintained.

### Example 4

### Fire Ratings Tests

Fire-resistant materials of this invention were subjected to fire-rating tests. A 2-hour Fire Endurance Test (495-1543) and a Hose Stream Test (495-1544) were conducted on a transparent composite panels of this invention installed in a gypsum board wall. Tests were conducted in accordance with the Standards for Fire Tests of Building Construction and Materials, ASTM E 119-98, UBC Standard 7-1 (1997), NFPA 251 (1999) and UL 263 (1997).

The test panels were as follows:

Panel A; nominal 17½″ wide×125¾″ high, clear view 16″ wide×124″ high.

Panel B: nominal 65¾″ wide×71¾″ high, clear view 64″ wide×70″ high.

Panel C: nominal 107⅞″ wide×47⅝″ high, clear view 106″ wide×46″ high.

Panel D: nominal 35-58″ wide×71⅝″ high, clear view 34″ wide×70′ high.

Average panel thickness: 1.512″.

The above test panels were placed in a test wall 144″ wide×135″ high×5-12″ thick consisting of two layers of ⅝″, Type X gypsum wallboard on each side of 3″×3″, 14 gauge tube steel. Glazing openings in the wall were lined along the perimeter with two layers of ⅝″ Type X gypsum board. Transparent panels were installed using Type X gypsum board and 10 gauge, ⅝″ high×⅞″ wide steel angle stops and wood setting blocks. The panels were glazed with cell foam tape ⅝″ side×nominally ⅛″ thick. Caulking was UL listed 3M CP 25WB+ fire barrier.

The Fire Endurance Test was started after igniting the burners and moving the test assembly into position in front of the furnace opening. Thermocouples were attached to automatic recording equipment. Temperatures within the furnace were monitored using 9 thermocouples. Temperatures were controlled by adjusting the flow of fuel to the burners to maintain the time/temperature curve specified in ASTM E 119-98.

FIG. 1 depicts the temperature produced by the furnace during the tests. For the first 10 minutes of the test, the temperature rose rapidly to about 1200° F. Thereafter, the temperature increased more slowly, so that by 120 minutes, the temperature was about 1700° F.

Periodic observations were made and recorded of conditions on the exposed an unexposed faces of the test assembly. In Test 495-1543, unexposed surface temperatures of the wall were recorded with 12 thermocouples.

Three pressure taps were installed trough the vertical centerline of the furnace wall adjacent to the wall at the bottom, mid-height and top elevations to measure furnace pressures. The pressure taps were attached to pressure gauges. Readings from these gauges (in inches of water) were monitored. Furnace pressure was controlled by adjusting the opening of the dampers in the furnace exhaust stacks.

Fire Endurance Test 495-1543 was conducted for 2 hours and 3 minutes. The results of Test 495-1543 are presented in Tables 1 and 2 below.

TABLE 1
Fire Endurance Test 495-1543 of Exposed Surface

| Test Time (Hr:Min) | Observations |
|---|---|
| 0:04 | Inside layer of Glazing A shattered and fell out. |
| 0:05 | Inside layer of Glazing D shattered and fell out. |
| 0:10 | Inner layer of glazing is black. |
| 0:15 | No change. |
| 0:30 | Inner layer is white. |
| 0:45-2:03 | No change. |

TABLE 2
Fire Endurance Test 495-1543 of Unexposed Surface

| Test Time (Hr:Min) | Observations |
|---|---|
| 0:03 | Bubbles in inner glazing layer. |
| 0:06 | Glazing is opaque. |
| 0:10-0:15 | No change. |
| 0:20 | Dark spots in inner layer of Glazing B and C. |
| 0:30 | No change. |
| 0:45 | Glazing C inner layer delaminating from outer glass along top edge. |
| 1:00 | Delamination increasing along top edge of Glazing C. Delamination |
| | along bottom edge of Glazing B. |
| 1:10 | Small glow spots on Glazing B, C and D where inner layer has |
| | cracked and separated. Smoke coming out at top of Glazing B. |
| 1:15 | Increased smoking at top edge of Glazing B. Inner and outer layers of |
| | Glazing B delaminating at top edge. |
| 1:20 | Wall is charred at top edge of Glazing B and there is a gap between |
| | the glazing and wall stop. |
| 1:30 | Glow spots along top edge of Glazing B. |
| 1:45 | Wall framing bowing into furnace. |
| 1:49 | Continuous flaming at top edge of Glazing B. Failure of Glazing B. |
| 2:03 | Test stopped. |

The average and maximum temperature rises on the unexposed surface at the end of the test were 141° F. and 293° F., respectively (recorded by Thermocouple 8). The average and maximum temperature rises allowed by the standards are 250° F. and 325° F., respectively.

We conclude that composite panels A, C and D described, complied with the requirements specified in Standard Test Methods for Fire Tests of Building Construction and Materials, ASTM E 119-98, UBC Standard 7-1 (1997) NFPA 251 (1999) and UL 263 (1997) for a 2-hour fire rated wall.

One hour and 49 minutes into this test, flaming occurred on the unexposed surface of transparent composite Panel B. Therefore, Panel B complied with the requirements for a 1-hour fire rated wall.

### Example 5

### One Hour Fire Endurance Test

We conducted Fire Endurance Test 495-1544 similar for the test described above in Example 5, but for a duration of one hour.

The results of Fire Test 494-1544 are presented in Tables 3 and 4 below.

TABLE 3
Fire Endurance Test 495-1544 Exposed Surface

| Test Time (Min) | Observations |
|---|---|
| 5 | Inside layer of Glazing A and D shattered and fell out. |
| 7 | Inside layer of Glazing B and C shattered and fell out. |
| 10 | Inner layer expanding, bubbling and black. |
| 15 | No change. |
| 30 | Inner layer is white. |
| 45 | Cracks on inner layer of all glazing. |
| 60 | Test stopped. |

TABLE 4
Fire Endurance Test 495-1544 Unexposed Surface

| Time (Min) | Observations |
|---|---|
| 5 | Bubbles in Glazing A, B and D. |
| 10 | Glazing becoming opaque. |
| 15 | No change. |
| 30 | Dark spots on Glazing B. |
| 45-60 | No change. |

### Example 6

### Hose Stream Test

Immediately after the 1 Hour Fire Endurance Test (495-1544) described above, the test assembly was moved into position for a Hose Stream Test. The exposed surface of the test assembly was subjected to the impact, erosion and cooling effects of a hose stream for 3 minutes 26 seconds (2-1/2 min/100 ft²) with a water pressure of 30 psi.

The wall and transparent composite panels withstood the Hose Stream Test without developing any openings through the assembly.

### Example 7

### Heat of Polymerization

We have found that under certain circumstances, the heat of polymerization of a fire-retardant gel mixture can be greater than that expected based on the polymerization of the gel alone. It is reported that the heat of polymerization of acrylamide gels is 20.4 Kcal/gm mole. It is also known that during polymerization of acrylamide gels, a 3° C. increase per 1% of monomer (on a dry basis) indicates complete polymerization.

We mixed a sample of(5% weight/weight) of NMA2820, a product manufactured byFlocryl™; 15% (weight/weight) of Bio-Acrylamide 50™ (a 50% acrylamide solution in water with stabilizers), a product manufactured by Flocryl™, and Pyrovatex CP New™ together and monitored the temperature of the mixture during polymerization. To monitor the heat of polymerization, we used a scanning thermocouple thermometer interfaced with a computer capable of recording the temperature of a solution. Data was collected from samples of gel immediately after mixing the components together. The temperature data was collected and stored in a memory device associated with the computer, and the lag time, initial temperature, maximum temperature, and the change in temperature (maximum temperature−initial temperature) were recorded.

According to one theory, the temperature increase=3×([% NMA2820]×0.48)+([% Bio-acrylamide]×0.5)+[% N,N′-methylolbisacrylamide]. Thus, the predicted temperature increase would be 3×(5×0.48)+(15×0.5)+(0.008)=3×9.908=29.724° C. However, we unexpectedly found that the difference in temperature was 32.9° C., indicating that more heat was released during the reaction (10.77% more) than could be accounted for by 100% polymerization of the acrylamide and N,N′-methylolbisacrylamide alone. Thus, we conclude that the excess heat generated during the polymerization reaction arose from polymerization of the fire-retardant material into the matrix of the acrylamide gel. Although we do not intend to be bound to any particular theory to account for the increased heat of polymerization observed, the increased heat released may indicate that the fire-resistant material formed covalent bonds with the polymers in the gel through an exothermic reaction.

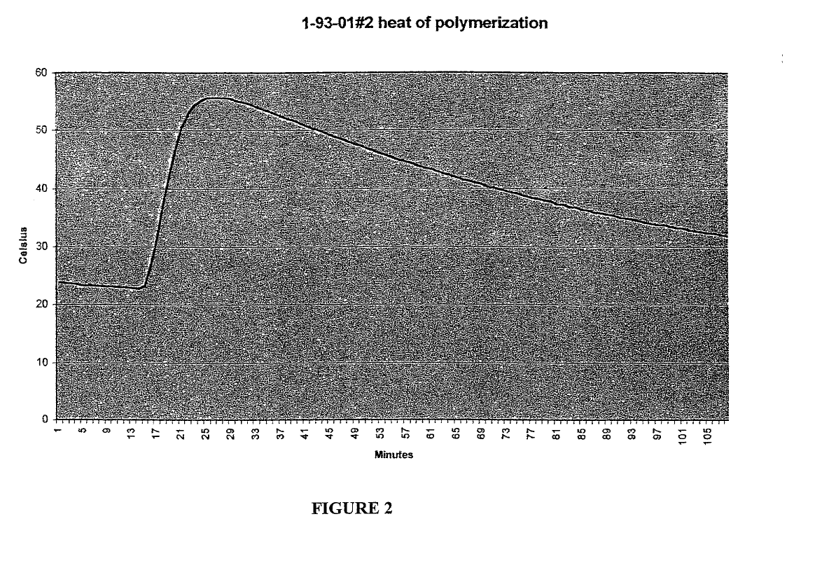

FIG. 2 depicts results of a typical experiment in which we monitored the temperature of a polymerization mixture during polymerization. After a lag period of about 16 minutes, the temperature increased rapidly to a maximum of about 56° C. at about 26 minutes. The temperature thereafter decreased slowly, so that after 109 minutes, the temperature was about 32° C.

### Example 8

### Fire Retardant Materials Polymerized with Gels

In another study, we made a series of gels having acrylamide monomers in the range of between about 8 and about 12% (weight/weight). The amounts of acrylamide, -methylolacrylamide and N,N′-methylenebisacrylamide were selected to form a gel which is tacky and flexible enough to deform without cracking yet resilient enough to stay in place when the glazing, facing the fire during abum test, breaks or shatters. The pH of the mixture was adjusted to above about 8.5 using a dilute solution 1% (w/w) solution of alkali such as sodium hydroxide in water, and sufficient urea was added to scavenge formaldehyde in Pyrovatex CP New™. This decreased the hydrolysis of the Pyrovatex CP New™ and/or decreases the formation and precipitation of magnesium hydroxide.

In alternative embodiments, an oxygen scavenger such as sodium metabisulfite can be used as an oxygen scavenger, or degassing using vacuum can be used to decrease the amount of oxygen in the gel.

A ratio of triethanolamine (TEA) to sodium persulfate was chosen to promote complete polymerization (about 4 parts per million (ppm)) of residual acrylamide monomer. A sample of the gel described in Example 1 was dried and assayed using high pressure liquid chromatography (HPLC), and we determined that there was 0.46% of free acrylamide and 0.55% free NMA. The amount of free monomers is substantially less than prior art gels.

TABLE 5
Formulations for Manufacturing Fire-Resistant Polymer Materials

| Material | % (wt/wt) | Ranges of wt % |
|---|---|---|
| Deionized Water | 50.73 | |
| MgCl | 15 | 5-20; 15 |
| NMA 2820 | 5 | 0-10; 0.5-8; 1-7; 5-6; 5 |
| Bio-Acrylamide | 15 | 5-20; 5-15; 10-15; 15 |
| N,N-methylene- | 0.8 | 0.2-2; 0.5-1; 0.8 |
| bisacrylamide (1% solution) | | |
| Pyrovatex CP ™ | 10 | 5-20 |
| pH: adjusted with NaOH (0.25 N) | 8.6-9.0 | 7.5-9; 8-9; 8.6-9 |
| TEA | 0.1 | sufficient to polymerize acrylamide; 0.05-1 |
| Urea | 0.22 | sufficient to neutralize formaldehyde; 0.1-2 |
| Sodium persulfate | 0.15 | sufficient to polymerize acrylamide; 0.05-1 |

### Example 9

### Burn Test of Polymerized Pyrovatex™

Insulated glass units (GU),24 inches by 24 inches, were prepared using tempered glass panels ¼ inch thick and variable spacers, with the space between the two glass panels being either ½″, ⅝″, or 1 ″. Panel spaces were filled with the fire retardant gel from Example 8 and submitted to a Fire Endurance Test as described in Example 5, but without the fire hose test. The panel with 1 ″ fire retardant gel was tested for 185 minutes. At the end of the test the 1 ″ panel was intact and the temperature inside the oven was 2,000° F. The panel with ⅝″ fire retardant gel was tested for 120 minutes. At the end of the test the ⅝″ panel was intact and the temperature inside the oven was 1,850° F. The panel with ¼″ fire retardant gel was tested for 70 minutes. At the end of the test the ¼″ panel was intact and the temperature inside the oven was 1,765° F. Thus, the fire-retardant panels of this invention demonstrated increased fire-resistance than conventional fire-resistant glazing.

This invention is described as specific embodiments thereof Other configurations, materials and methods within the scope of the art can be equivalently used, and all such embodiments are considered to be part of this invention.

### INDUSTRIAL APPLICABILITY

The fire-resistant materials of this invention are useful in any industrial application in which improved fire resistance is desired. The fire-resistant material can be used for any construction purpose where vision, radiant heat protection, safety and a fire rating is required. The applications include those for schools, hospitals, factories, property lines, hulls, nuclear reactors and anyplace requiring a fire rating for safety of persons or property. The fire-resistant materials can be thinner, weigh less, have larger surface area, and can be more aesthetically pleasing than prior art fire-resistant transparent materials. The methods of this invention permit that rapid, accurate manufacture of fire-resistant transparent materials with increased efficiency and reduced cost.

We claim:

1. A fire-resistant polymer material, comprising:
a polymer; and
a reactive flame retardant chemical, wherein said fire-resistant polymer material is transparent and intumescent.

2. The fire-resistant polymer material of claim 1, wherein the fire-retardant chemical forms a bond with said polymer.

3. The fire-resistant polymer of claim 1, wherein said polymer comprises acrylamide, bisacrylamide, an initiator and a catalyst.

4. The fire-resistant polymer of claim 1, further comprising a second fire-retardant chemical selected from the group consisting of bromine and chlorine for a total of about 60%, organic halogen compounds, phosphorous containing polyol, boron-phosphate, modified organic halogens, di-linoleic acid/tri-linoleic acid/ethylene diamine copolymers, polyphosphate-nitrogen liquid, inorganic salts, acrylic polymer compounds, dibutyl butylphosphonate, antimony oxide, antimonyperoxide, sodium borate, barium metaborate, alumina trihydrate, magnesium hydroxide, decabromodiphenyl oxides, vinyl bromide, dimethylphosphonate, and/or dibromoneopentyl glycol, dialkyl phosphorus carboxyl amide-TMM, dialkyl phosphorus carboxyl amide, oligomeric 2-chloroethyl phosphate, dimethyl methylphosphonate, halogenated compound Z, organic phosphate Y, chlorinated paraffin W, organic phosphate X and NT aqua fire retardant, organophosphorus monomers, phosphorus-containing diols phosphorous-containing polyols, phosphonomethylated ethers, amide-cyanamides, halogenated alkyl, aryl or alkenyl phosphates, halogenated alkyl, aryl or alkenyl phosphonates and halogenated dialkyl diaryl or dialkenyl phosphites.

5. The fire-retardant polymer material of claim 1, wherein said polymer material is disposed between spaces between two or more sheets of transparent material, thereby forming a fire-resistant transparent material.

6. The fire-resistant transparent material of claim 5, wherein said sheets of transparent material are selected from the group consisting of tempered glass, laminated glass, annealed glass, plastic, fiberglass and masonite.

7. The fire-resistant polymer material of claim 1, wherein said reactive flame retardant chemical is selected from the group consisting of dialkyl phosphorus carboxyl Amide-TMM, dialkyl phosphorus carboxyl amide, oligomeric 2-chloroethyl phosphate, dimethyl methylphosphonate, organophosphorus monomers, phosphorus-containing diols phosphorous-containing polyols, phosphonomethylated ethers, amide-cyanamides, halogenated alkyl, aryl or alkenyl phosphates, halogenated alkyl, aryl or alkenyl phosphonates and halogenated dialkyl diaryl or dialkenyl phosphites.

8. The fire-resistant polymer of claim 1, wherein said polymer comprises an acrylamide polymer.

9. A fire-resistant transparent material comprising:
at least one sheet of transparent material;
a fire resistant polymer; and
a reactive fire retardant chemical.

10. The fire resistant transparent material of claim 9, wherein said reactive flame retardant chemical is selected from the group consisting of dialkyl phosphorus carboxyl amide-TMM, dialkyl phosphorus carboxyl amide, oligomeric 2-chloroethyl phosphate, dimethyl methylphosphonate, organophosphorus monomers, phosphorus -containing diols phosphorous-containing polyols, phosphonomethylated ethers, amide-cyanamides, halogenated alkyl, aryl or alkenyl phosphates, halogenated alkyl, aryl or alkenyl phosphonates and halogenated dialkyl diaryl or dialkenyl phosphites.

11. The fire resistant transparent material of claim 9, wherein said polymer further comprises a second fire retardant material.

12. The fire resistant material of claim 11, wherein said fire retardant material is selected from the group consisting of bromine and chlorine for a total of about 60%, organic halogen compounds, phosphorous containing polyol, boron-phosphate, modified organic halogens, di-linoleic acid/tri-linoleic acid/ethylene diamine copolymers, polyphosphate-nitrogen liquid, inorganic salts, acrylic polymer compounds, dibutyl butylphosphonate, antimony oxide, antimony peroxide, sodium borate, barium metaborate, alumina trihydrate, magnesium hydroxide, decabromodiphenyl oxides, vinyl bromide, dimethylphosphonate, and/or dibromoneopentyl glycol, dialkyl phosphorus carboxyl amide-TMM, dialkyl phosphorus carboxyl amide, oligomeric 2-chloroethyl phosphate, dimethyl methylphosphonate, organophosphorus monomers, phosphorus -containing diols phosphorous-containing polyols, phosphonomethylated ethers, amide-cyanamides, halogenated alkyl, aryl or alkenyl phosphates, halogenated alkyl, aryl or alkenyl phosphonates and halogenated dialkyl diaryl or dialkenyl phosphites.

13. The fire-resistant transparent material of claim 9, wherein said polymer is substantially free of bubbles at temperatures below about 100° C.

14. A method for manufacturing a fire-resistant polymer material, comprising the steps of:
mixing an aqueous solution of a monomer with a reactive fire-retardant chemical; and
polymerizing said solution, wherein said fire-resistant polymer material is at least one of intumescent and transparent.

15. The method of claim 14, wherein said polymer is formed from an aqueous solution of acrylamide monomers, an initiator, formaldehyde and a catalyst.

16. The method of claim 14, wherein said monomer comprises a material selected from the group consisting of acrylamide, methylene bisacrylamide, N-methylol acrylamide, poloxamers, polyethylene glycols, polyethylene glycol monomethyl ethers, and polysorbates.

17. The method of claim 14, further comprising adding a salt.

18. The method of claim 17, wherein said salt comprises magnesium chloride.

19. The method of claim 14, wherein said initiator comprises sodium persulfate.

20. The method of claim 14, further comprising the step of adding a second fire-retardant chemical selected from the group consisting of bromine and chlorine for a total of about 60%, organic halogen compounds, phosphorous containing polyol, boron-phosphate, modified organic halogens, di-linoleic acid/tri-linoleic acid/ethylene diamine copolymers, polyphosphate-nitrogen liquid, inorganic salts, acrylic polymer compounds, dibutyl butylphosphonate, antimony oxide, antimony peroxide, sodium borate, barium metaborate, alumina trihydrate, magnesium hydroxide, decabromodiphenyl oxides, vinyl bromide, dimethylphosphonate, and/or dibromoneopentyl glycol, dialkyl phosphorus carboxyl amide-TMM, dialkyl phosphorus carboxyl amide, oligomeric 2-chloroethyl phosphate, dimethyl methylphosphonate, organophosphorus monomers, phosphorus-containing diols phosphorous-containing polyols, phosphonomethylated ethers, amide-cyanamides, halogenated alkyl, aryl or alkenyl phosphates, halogenated alkyl, aryl or alkenyl phosphonates and halogenated dialkyl diaryl or dialkenyl phosphites.

21. The method of claim 14, wherein said polymer is made from a solution comprising about 51% water, about 7% to about 12% acrylamide, and about 4% NMA 2820.

22. The method of claim 15, wherein said percentage of acrylamide is in the range of about 8% to about 12%.

23. The method of claim 15, wherein the percentage of acrylamide is in the range of about 7.5%.

24. The method of claim 15, wherein said initiator is triethanolamine.

25. The method of claim 24, wherein the amount of triethanolamine is from about 0.05% to about 1% by weight.

26. The method of claim 15, wherein said catalyst is sodium persulfate.

27. The method of claim 26, wherein the amount of sodium persulfate is from about 0.05% to about 1% by weight.

28. A method of manufacturing a fire-resistant transparent material, comprising the steps of:
providing at least one sheet of transparent material;
applying a fire-resistant polymer material comprising a polymer and a reactive fire-retardant chemical to said transparent material; and
permitting said fire-resistant polymer material to polymerize, said fire-resistant polymer material is at least one of transparent and intumsecent.

29. The method of claim 28 wherein the polymer is acrylamide in the range of about 5% to about 15% by weight.

30. The method of claim 28 wherein the polymer is acrylamide in an of about 7.5% by weight.

31. A method for protecting a structure from fire, comprising the steps of:
selecting a structure subject to fire damage; and
applying a coating of the fire-resistant polymer of claim 1 thereto.

32. The method of claim 31, wherein said polymer comprises acrylamide.

33. The method of claim 31, further comprising adding a second fire-retardant chemical selected from the group consisting of bromine and chlorine for a total of about 60%, organic halogen compounds, phosphorous containing polyol, boron-phosphate, modified organic halogens, di-linoleic acid/tri-linoleic acid/ethylene diamine copolymers, polyphosphate-nitrogen liquid, inorganic salts, acrylic polymer compounds, dibutyl butylphosphonate, antimony oxide, antimony peroxide, sodium borate, barium metaborate, alumina trihydrate, magnesium hydroxide, decabromodiphenyl oxides, vinyl bromide, dimethylphosphonate, and/or dibromoneopentyl glycol, dialkyl phosphorus carboxyl amide-TMM, dialkyl phosphorus carboxyl amide, oligomeric 2-chloroethyl phosphate, dimethyl methylphosphonate, organophosphorus monomers, phosphorus -containing diols phosphorous-containing polyols, phosphonomethylated ethers, amide-cyanamides, halogenated alkyl, aryl or alkenyl phosphates, halogenated alkyl, aryl or alkenyl phosphonates and halogenated dialkyl diaryl or dialkenyl phosphites.

34. The transparent fire-resistant material of claim 5, wherein said material passes a two-hour fire endurance test and has a thickness of about 1.5 inches.

35. The fire-resistant polymer material of claim 1, further comprising a radiation shielding material.

36. The fire-resistant polymer material of claim 35, wherein said radiation shielding material comprises lead.

37. A fire-resistant hull comprising the fire-resistant polymer material of claim 1.

38. A fire-resistant fabric comprising:
a fabric; and
the fire resistant polymer material of claim 1 applied to said fabric.

39. A method for protecting an object from fire, comprising the step of coating said object with the fire-resistant polymer material of claim 1 sufficient to protect said object from fire damage.

40. The method of claim 40, wherein said fire-resistant polymer further comprises a second fire -retardant chemical selected from the group consisting of bromine and chlorine for a total of about 60%, organic halogen compounds, phosphorous containing polyol, boron-phosphate, modified organic halogens, di-linoleic acid/tri-linoleic acid/ethylene diamine copolymers, polyphosphate-nitrogen liquid, inorganic salts, acrylic polymer compounds, dibutyl butylphosphonate, antimony oxide, antimony peroxide, sodium borate, barium metaborate, alumina trihydrate, magnesium hydroxide, decabromodiphenyl oxides, vinyl bromide, dimethylphosphonate, -and/or dibromoneopentyl glycol, dialkyl phosphorus carboxyl amide-TMM, dialkyl phosphorus carboxyl amide, oligomeric 2-chloroethyl phosphate, dimethyl methylphosphonate, organophosphorus monomers, phosphorus-containing diols phosphorous-containing polyols, phosphonomethylated ethers, amide-cyanamides, halogenated alkyl, aryl or alkenyl phosphates, halogenated alkyl, aryl or alkenyl phosphonates and halogenated dialkyl diaryl or dialkenyl phosphites.

41. A fire-resistant polymer material, comprising:
a polymer; and
means for bonding a reactive fire retardant chemical to said polymer, said fire-resistant polymer material being at least one of intumescent and transparent.

42. A fire-resistant transparent material, comprising:
a transparent polymer; means for bonding a fire-retardant chemical to said polymer; and
means for supporting said fire-retardant chemical.

43. A fire-resistant wall comprising a fire-resistant polymer material of claim 1.

44. The fire-resistant wall of claim 43, wherein said fire-resistant polymer material is in the interior of said wall.

45. The fire-resistant polymer material of claim 1, comprising at least two fire-retardant chemicals, one of said fire-retardant chemicals being bonded with said polymer.

46. The fire-resistant polymer material of claim 8, wherein said polymer is formed from a solution comprising about 0% to about 10% NMA 2820, about 5% to about 20% of a stock 50% solution of acrylamide in water and 0.2% to about 3% of a 1% solution of N,N′-methylenebisacrylamide.

47. The fire-resistant polymer material of claim 8, wherein said polymer is made from a solution comprising about 0.5% to about 8%NMA2820, about 5% to about 20% of a stock 50% solution of acrylamide in water and 0.2% to about 3% of a 1% solution of N,N′-methylenebisacrylamide.

48. The fire-resistant polymer material of claim 8, wherein said polymer is made from a solution comprising about 1% to about 7% NMA 2820, about 5 to 20% of a stock 50% solution of acrylamide in water and 0.2% to about 3% of a 1% solution of N,N′-methylenebisacrylamide.

49. The fire-resistant polymer material of claim 8, wherein said polymer is made from a solution comprising about 5% to about 6% NMA 2820, about 5% to 20% of a stock 50% solution of acrylamide in water and 0.2% to about 3% of a 1% solution of N,N′-methylenebisacrylamide.

50. The fire-resistant polymer material of claim 8, wherein said polymer is made from a solution comprising about 5% NMA 2820, about 5% to 20% of a stock 50% solution of acrylamide in water and about 0.2% to about 3% of a 1% solution of N,N′-methylenebisacrylamide.

51. The fire-resistant polymer material of claim 8, wherein said polymer is made from a solution comprising about 0.5% to about 8% NMA 2820, about 5 to 15% of of a stock 50% solution of acrylamide in water and 0.2% to about 3% of a 1% solution of N,N′-methylenebisacrylamide.

52. The fire-resistant polymer material of claim 8, wherein said polymer is made from a solution comprising about 0.5% to about 8% NMA 2820, about 10 to 15% of a stock 50% solution of acrylamide in water and 0.2% to about 3% of a 1% solution of N,N′-methylenebisacrylamide.

53. The fire-resistant polymer material of claim 8, wherein said polymer is made from a solution comprising about 0.5% to about 8% NMA 2820, about 15% of a stock 50% solution of acrylamide in water and 0.2% to about 3% of a 1% solution of N,N′-methylenebisacrylamide.

54. The fire-resistant polymer material of claim 8, wherein said polymer is made from a solution comprising about 0.5% to about 8% NMA 2820, about 5% to 20% of a stock 50% solution of acrylamide in water and 0.2% to about 2% of a 1% solution of N,N′-methylenebisacrylamide.

55. The fire-resistant polymer material of claim 8, wherein said polymer is made from a solution comprising about 0.5% to about 8% NMA 2820, about 5% to about 20% of a stock 50% solution of acrylamide in water and 0.5% to about 1% of a 1% solution of N,N′-methylenebisacrylamide.

56. The fire-resistant polymer material of claim 8, wherein said polymer is made from a solution comprising about 0.5% to about 8% NMA 2820, about 5% to about 20% of a stock 50% solution of acrylamide in water and about 0.8% of a 1% solution of N,N′-methylenebisacrylamide.

57. The method of claim 14, further comprising the step of adding a second fire-retardant chemical selected from the group consisting of bromine and chlorine for a total of about 60%, organic halogen compounds, phosphorous containing polyol, boron-phosphate, modified organic halogens, di-linoleic acid/tri-linoleic acid/ethylene diamine copolymers, polyphosphate-nitrogen liquid, inorganic salts, acrylic polymer compounds, dibutyl butylphosphonate, antimony oxide, antimony peroxide, sodium borate, barium metaborate, alumina trihydrate, magnesium hydroxide, decabromodiphenyl oxides, vinyl bromide, dimethylphosphonate, and/or dibromoneopentyl glycol, dialkyl phosphorus carboxyl amide-TMM, dialkyl phosphorus carboxyl amide, oligomeric 2-chloroethyl phosphate, dimethyl methylphosphonate, organophosphorus monomers, phosphorus-containing diols phosphorous-containing polyols, phosphonomethylated ethers, amide-cyanamides, halogenated alkyl, aryl or alkenyl phosphates, halogenated alkyl, aryl or alkenyl phosphonates and halogenated dialkyl diaryl or dialkenyl phosphites.

58. The method of claim 14, wherein said fire-resistant polymer material comprises magnesium chloride hexahydrate and dialkyl phosphorus carboxyl amide.

59. The method of claim 58, further comprising the step of adjusting the pH of said solution to between about 7.5 and about 9.0 with sodium hydroxide.

60. The method of claim 28, wherein the polymer is acrylamide in an amount in the range of about 10% to about 15% by weight.

61. A method for manufacturing a fire-resistant transparent material comprising the steps of:
providing at least two sheets of transparent material positioned relative to each another to define a space therebetween;
filling said space with a mixture of a monomer solution and a reactive fire-resistant chemical; and permitting said solution to polymerize into an intumescent polymer.

62. The method of claim 15, further comprising the step of adding sufficient urea to neutralize the formaldehyde.

63. The method of claim 62, wherein the amount of urea is in the range of about 0.05% and about 2% by weight.

64. The method of claim 15, wherein said polymerizing agent is selected from the group consisting of triethanolamine and sodium persulfate and wherein said polymerizing agent is in an amount between about 0.05% and about 1% by weight.

65. The method of claim 14, wherein the heat of polymerization observed during the step of polymerizing is greater than 100% of the heat of polymerization for a polymer consisting of acrylamide alone without said reactive fire-retardant chemical.

66. The method of claim 14, where less than about 200 ppm of un-reacted monomers are left after the step of polymerization.

67. The fire-resistant material of claim 1, wherein less than about 200 ppm of un-reacted monomers are left after polymerization.

68. A method for manufacturing a fire-resistant transparent material comprising the steps of:
providing at least two sheets of transparent material positioned relative to each another to define a space therebetween;
filling said space with a mixture of a monomer solution and a reactive fire-retardant chemical; and
permitting said solution to polymerize, wherein the heat of polymerization observed during said polymerization step is greater than 100% of the heat of polymerization for a polymer consisting of acrylamide alone without said reactive fire-retardant chemical.

69. The method of claim 68, wherein said fire-resistant transparent material is intumescent.

70. A method for manufacturing a fire-resistant transparent material comprising the steps of:
providing at least two sheets of transparent material positioned relative to each another to define a space therebetween;
filling said space with a mixture of a polymer solution and a reactive fire-retardant chemical; and
permitting said solution to polymerize, wherein less than about 200 ppm of un-reacted monomers are left after polymerization.

71. The method of claim 70, wherein said fire-resistant transparent material is intumsecent.

72. A fire resistant transparent material, comprising:
at least two pieces of transparent material defining a space therebetween; and
a fire-resistant polymer material in said space, comprising:
a polymer; and
a reactive fire-retardant chemical;
wherein said fire-resistant polymer material has less than about 200 ppm of un-reacted monomers left after polymerization.

73. The material of claim 72, wherein said fire-resistant transparent material is intumescent.

74. The method of claim 14, wherein said monomer comprises a silicate.
